(19) United States
(12) Patent Application Publication
(10) Pub. No.: US 2011/0043082 A1
(43) Pub. Date: Feb. 24, 2011

(54) CONVERTER MOTOR

(75) Inventors: Markus Billmann, Emskirchen (DE); Konrad Domes, Chemnitz (DE); Hans-Dieter Heining, Bad Neustadt (DE); Hubert Schierling, Erlangen (DE); Richard Schmidt, Baiersdorf (DE); Heinrich Windischmann, Hochstadt (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/866,388

(22) PCT Filed: Oct. 13, 2008
(86) PCT No.: PCT/EP2008/063695

§ 371 Date: Nov. 5, 2010

(30) Foreign Application Priority Data
Feb. 7, 2008 (DE) 10 2008 007 825.5

(51) Int. Cl. H02K 11/00

(52) U.S. Cl. 310/68 R

(57) ABSTRACT

The invention relates to an inverter motor comprising a motor (2) and an inverter (4), wherein components of inverter electronics are disposed on a circuit board such that the lossy components are thermally conductively connected to a heat sink (8) designed as a cover of an inverter housing made of thermally insulating plastic, wherein said inverter housing made of thermally insulating plastic is axially mounted on a B-side of the motor (2). According to the invention, the circuit board (14) is divided into a plurality of circuit board elements edged relative to each other such that circuit board segments having components having lower power loss are each thermally conductively connected to a wall of an inverter housing wall (6), and that a central circuit board segment having lossy components is thermally conductively connected to a heat sink made of thermally conductive plastic, and the motor (2) has a bulkhead (16) made of thermally insulating material on the B side thereof, whereon a connector strip (18) is disposed. The result is a compact, fanless inverter motor.

The invention relates to a converter motor as claimed in the pre-characterizing clause of claim 1.

The integration of a converter, in particular of a frequency converter, in a motor is a major feature of decentralized drive technology. Because of the space requirement and the requirement for compactness, as well as cost pressure, it is necessary in this case to generate as few design techniques as possible or less costly design techniques. Commercially available converter motors use either an axial or a radial design. In this case, the geometry of the motor is not specifically matched to the requirements. Motors from the standard range of the respective manufacturer are generally used.

DE 10 2005 032 971 A1 discloses a converter motor whose converter housing is attached axially to the non-drive end frame of the rotor. The components of converter electronics are arranged distributed on a plurality of printed circuit boards, which form a conductor run, by means of flexible electrical connecting elements. The printed circuit boards in this printed circuit board run are angled with respect to one another such that this printed circuit board run forms an envelope surface of a cuboid hollow cylinder, whose axis is arranged radially with respect to the axis of the motor in the converter housing. When the cuboid hollow cylinder is installed in this way, the lossy components of the converter electronics are thermally conductively connected to the non-drive end frame of the motor. In this installation position, heat is dissipated from the lossy components by means of the non-drive end frame, the motor housing and the drive-end frame. In order to improve the heat dissipation from the interior of the converter housing, the converter housing walls and the converter housing cover are composed of a thermally conductive material. If the heat dissipation is intended to be improved even further, then the converter housing cover is in the form of a heat sink. In this case, the cuboid hollow cylinder is arranged in the converter housing such that the lossy components in the converter electronics are thermally conductively connected to the converter housing cover which is in the form of a heat sink. A permanent-magnet synchronous motor is preferably used as the motor. A synchronous motor such as this has lower power losses than an asynchronous motor of the same power. Furthermore, this synchronous motor has a smaller physical size than an asynchronous motor of the same power.

A converter motor of this generic type is known from the prospectus entitled “TorqueWire servo systems” from the company PHASE Motion Control. In this converter motor, the components of the converter electronics are arranged on both sides of a printed circuit board, with the lossy components being arranged such that they are thermally conductively connected to a converter housing cover which is in the form of a heat sink. The power loss from the lossy components in the converter electronics is dissipated by convection cooling. The converter housing walls which cover a square area are composed of a thermally insulating material. The two heat sources, specifically the motor and the power section of the converter, are therefore decoupled from one another. These converter housing walls accommodate the converter electronics in the surrounding area. Since the converter housing cover which is in the form of a heat sink is composed of a metallic material, the lossy components must be connected to this heat sink such they are electrically isolated. This electrically insulating and thermally conductive interlayer adversely affects the heat transfer to the heat sink.

The invention is now based on the object of developing a converter motor of this generic type in such a way that its disadvantages no longer occur.

According to the invention, this object is achieved by the features of claim 1.

According to the invention, the printed circuit board for the converter electronics is subdivided into a plurality of printed circuit board segments, which are angled with respect to one another such that a cavity is created in which the components of the converter electronics are located. In this case, these components are arranged distributed on the individual printed circuit board segments such that each of the components with a low power loss are each thermally conductively connected to one wall of a converter housing wall. In addition, the lossy components are arranged flat on the printed circuit board segment with is associated with the heat sink, and the heat sink is composed of thermally conductive plastic. Converter electronics components which are not thermally critical are accommodated on printed circuit board segments which are located in the interior of the resultant cavity when the printed circuit board is folded. In order to prevent the converter electronics components from being subjected to the thermal radiation from the motor, this motor is provided at the non-drive end with a partition wall composed of thermally insulating material, on which a plug strip is arranged, by means of which the converter electronics are electrically conductively connected to the motor by plugging the converter housing axially on to the non-drive end of the motor.

The spatially distributed arrangement of the converter electronics components which produce power losses over the entire area of a printed circuit board segment which is thermally conductively connected to the plastic heat sink results in a geometric heat spreading effect, as a result of which the entire area of the heat sink is involved in the heat dissipation process. Since the heat sink is composed of a material which is thermally conductive but electrically insulating, the printed circuit board segment with the components which produce power losses need no longer be electrically isolated, as a result of which it no longer adversely affects the heat transfer between the printed circuit board segment and the heat sink.

In one advantageous embodiment of the converter motor, the walls of the converter housing wall are provided with radially running cooling ribs, which are axially separated from one another. This improves the heat transfer to the surrounding air, on the one hand improving the heat dissipation from the converter electronics and on the other hand improving the thermal decoupling of the motor and converter electronics.

In a further advantageous refinement of the converter motor, the heat sink composed of thermally conductive and electric insulating material is molded directly onto the side of the printed circuit board segment which faces away from the lossy components of the converter electronics. This considerably improves the thermal linking of this printed circuit board segment.

In a further advantageous refinement of the converter motor, the angled printed circuit board, which has a plurality of printed circuit board segments, of the converter electronics is encapsulated in the converter housing. This encapsulation provides sufficient protection for the converter electronics against shaking and/or vibration.

In order to keep the power loss from the converter motor as low as possible, in a further advantageous refinement of this converter motor, a permanent-magnet synchronous motor, in particular a synchronous motor with harmonic technology, is provided as the motor. This permanent-magnet synchronous motor produces less losses than an asynchronous motor of the same power. At the same time, a synchronous motor such as this occupies less physical space than an asynchronous motor of the same power, thus reducing the space required for a converter motor with a permanent-magnet synchronous motor.

In order to explain the invention further, reference is made to the drawing, which schematically illustrates a converter motor according to the invention.

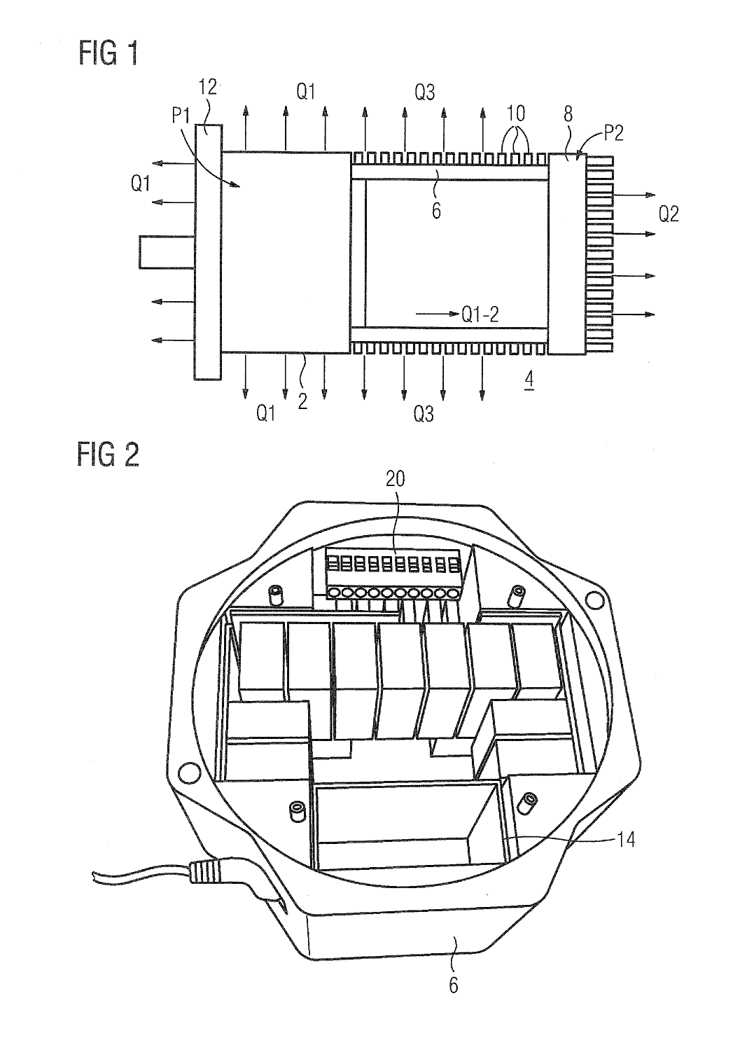

FIG. 1 shows an outline illustration of the converter motor according to the invention,

FIG. 2 shows a view into the interior of converter electronics in a converter housing of the converter motor as shown in FIG. 1,

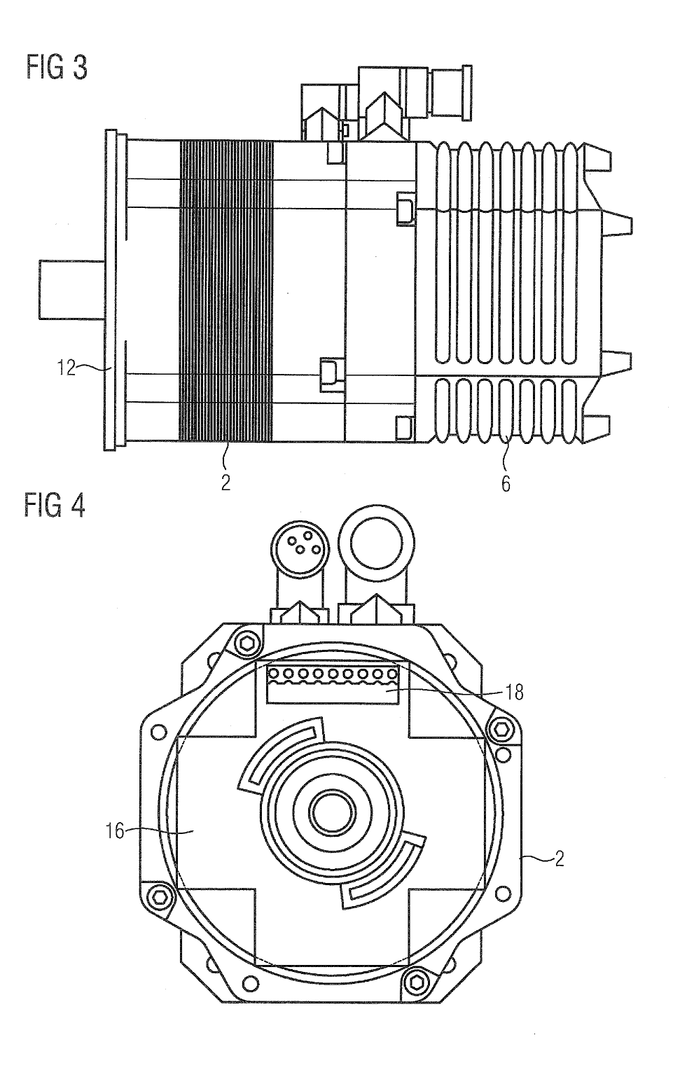

FIG. 3 shows a side view of a motor with a flange-connected converter housing of the converter motor as shown in FIG. 1,

FIG. 4 shows the view of a non-drive end partition wall of the motor of the converter motor as shown in FIG. 1,

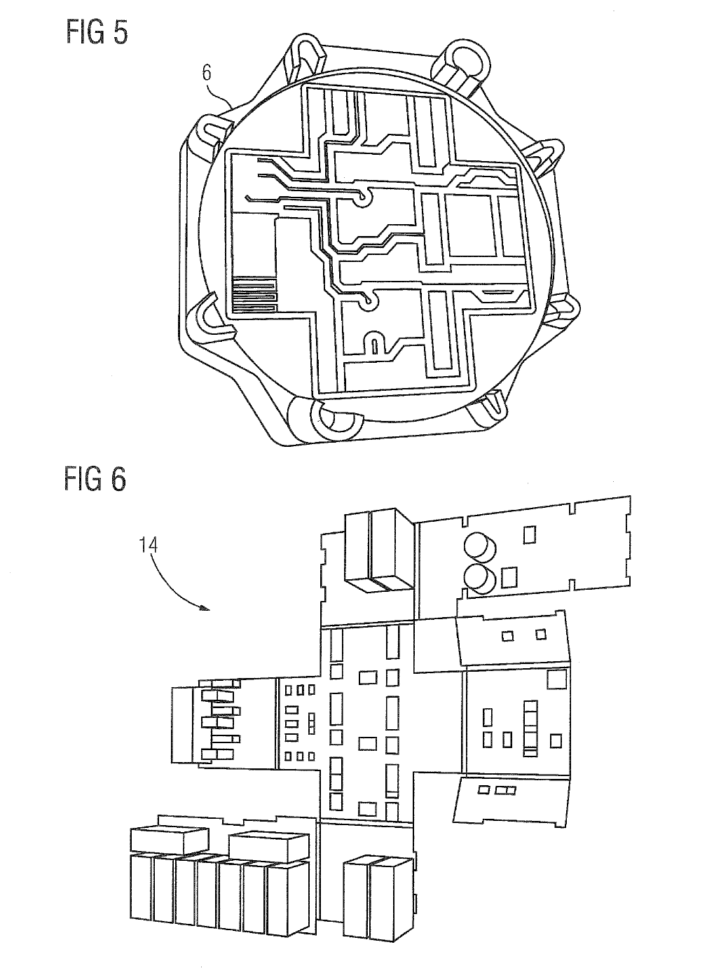

FIG. 5 shows a central printed circuit board segment in the converter housing wall of the converter motor as shown in FIG. 1, and

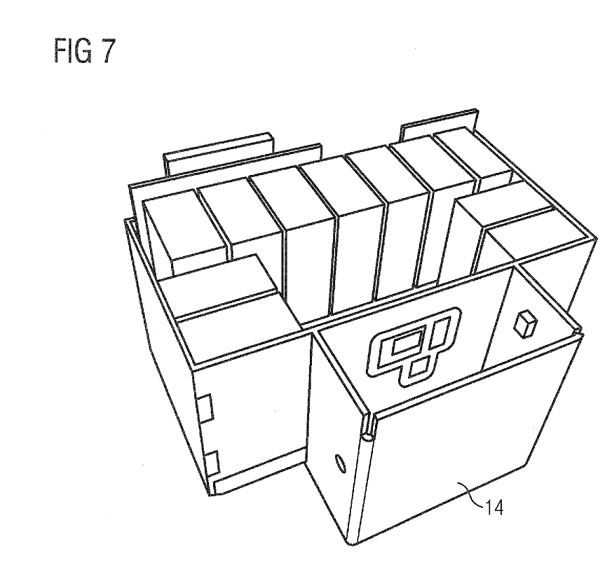

FIG. 6 shows a view of the component side of a printed circuit board, which is subdivided into a plurality of printed circuit board segments, of converter electronics of a converter motor as shown in FIG. 1, while in contrast FIG. 7 shows the printed circuit board as shown in FIG. 6, after folding.

In the outline illustration shown in FIG. 1, 2 denotes a motor, in particular a permanent-magnet synchronous motor, and 4 denotes a converter. The converter 4 is split in two. One part is the converter housing wall 6, and the second part is the heat sink 8, which is in the form of a cover. In this illustration, the converter housing wall 6 is provided with axially running cooling ribs 10, which are axially separated. In a converter motor, the motor 2 and the power electronics of the converter 4 respectively form a main heat source P1 and P2. Since the converter electronics (power electronics) components which produce power losses are indirectly thermally connected to the heat sink 8, the main heat source P2 is the heat sink 8, which dissipates the power loss. These two main heat sources P1 and P2 are thermally decoupled by the converter housing wall 6 composed of a thermally insulating material. This decoupling means that a heat flow Q1 is emitted only via a motor flange 12 of the motor 2 and via the surface of this motor 2 to a surrounding area. A heat flow Q2 from the power electronics is emitted to the surrounding air via the heat sink 8 by natural convection. A heat flow Q3 from a third heat source P3, specifically signal electronics in the converter electronics, is emitted to the surrounding air via the converter housing wall 6, whose surface areas are enlarged by means of a number of cooling ribs 10. Despite the thermal resistance of the thermally insulating material of the converter housing wall 6, the relatively large area of this converter housing wall 6 results in a sufficiently good heat flow Q3 to the surrounding area. There is virtually no heat flow Q1-2 between these two heat sources P1 and P2, since the cross-sectional area of the converter housing wall 6 is relatively small, and the heat travels parallel to the converter housing wall 6.

FIG. 2 shows a view into the interior of the converter electronics of a converter motor as shown in the outline illustration in FIG. 1. This illustration shows the converter housing wall 6 and a folded printed circuit board 14 for the converter electronics. This folded printed circuit board 14 is illustrated in more detail without the converter housing wall 6 in FIG. 7, illustrating the populated printed circuit board 14 before folding in FIG. 6. This folded printed circuit board 14 forms a cavity which accommodates converter electronics components. In this case, the converter electronics components which either have to be kept at a low temperature level, for example a microprocessor, or produce losses themselves only to a minor extent, are arranged on printed circuit board segments of this printed circuit board 14 which dissipate heat directly by flat area contacts with the walls of the converter housing wall 6, which is produced from a thermally insulating material. Converter electronics components which are not thermally critical are arranged on printed circuit board segments of the printed circuit board 14 which are located in the interior of a cavity that is formed after the printed circuit board segments of the printed circuit board 14 have been folded. Such distribution of the signal electronics components of the converter electronics between predetermined printed circuit board segments of the printed circuit board 14 makes good use of the available physical volume.

The side view of the converter motor shown in FIG. 3 illustrates the motor 2, in particular a permanent-magnet synchronous motor, and the converter housing wall 6 of the converter 4, which is flange-connected to the non-drive end of the motor 2.

FIG. 4 shows the view of the non-drive end of the motor 2. This non-drive end is closed by a partition wall 16 composed of thermally insulating material. The internal area of the converter electronics formed by the folded printed circuit board 14 is therefore thermally shielded from the heat radiation from the motor 2. In order to make electrical contact between the converter 4 and the motor 2, this thermal partition wall 16 has a plug strip 18, whose mating piece 20 can be seen in FIG. 2. When the populated converter housing wall 6 is flange-connected to the non-drive end of the motor 2, the plug strip 18 and its mating piece 20 engage in one another, thus resulting in output connections of the converter 4 being electrically conductively connected to terminal connections of the motor 2.

FIG. 5 shows a view of the solder side of the central printed circuit board segment of the printed circuit board 14, which has power electronics components of the converter electronics which produce losses. This means that this view shows the rear side of the folded printed circuit board 14 in the converter housing wall 6 as shown in FIG. 2. The power electronics components of the converter electronics are arranged on the averted side (component side) of this central printed circuit board segment. The plastic heat sink 8 is directly adhesively bonded to this side of this central printed circuit board segment. It is particularly advantageous for this plastic heat sink 8 to be molded directly on the solder side of the central printed circuit board segment, which has those components of the power electronics of the converter electronics which produce power losses. This substantially improves the heat transfer between the components which produce losses and the plastic heat sink 8.

By way of example, this plastic heat sink 8 is detachably attached to this converter housing wall 6.

As already mentioned, FIG. 6 shows the printed circuit board 14 with its populated printed circuit board segments. The associated folded printed circuit board 14 is illustrated in more detail in FIG. 7. Of this folded printed circuit board 14, the outer walls of the cavity that is formed can be seen which, after insertion into the converter housing wall 6, make area contact with the insides of the walls of the converter housing wall 6. The configuration of the foldable printed circuit board 14 in the form of a three-dimensional circuit arrangement is designed on the basis of thermodynamic aspects. In this case, the printed circuit board segment with the power electronics components distributed over an area is associated with the housing part of the converter housing with the thermally conductive plastic heat sink 8. Circuit parts with signal electronics components of the converter electronics which either have to be kept at a low temperature level or produce power losses only to a minor extent are arranged on printed circuit board segments of the printed circuit board 14 from which heat is dissipated by direct area contact with walls of the converter housing wall 6, which is produced from thermally insulating material. Signal electronics components of the converter electronics which are not thermally critical are arranged on printed circuit board segments of the printed circuit board 14 which are located in the interior of the resultant cavity after folding of the printed circuit board 14.

This cavity that is formed, with the signal and power electronics components of the converter electronics which project into this cavity, can be encapsulated with an encapsulating compound when this converter motor is used in a drive system which is subject to shaking and/or vibration.

The design according to the invention of the converter of a converter motor results in a compact converter motor without a fan, optimized for heat dissipation and mechanical design.

What is claimed is:

1.-8. (canceled)

9. A converter motor, comprising
a motor,
a converter having a converter housing with housing walls, said converter housing attached axially to a non-drive end of the motor,
a heat sink implemented as a cover of the converter housing and composed of thermally conductive plastic,
a printed circuit board having a plurality of printed circuit board segments arranged at an angle with respect to one another, with first printed circuit board segments thermally conductively connected to a wall of the converter housing and a second printed circuit board segment connected to the heat sink,
a partition wall composed of thermally insulating material disposed on the non-drive end of the motor, and
a plug strip arranged on the partition wall.

10. The converter motor of claim 9, wherein lossy components are arranged on the second segment and components with a low power loss are arranged on the first segments.

11. The converter motor of claim 9, wherein the wall of the converter housing walls comprises radially-extending cooling ribs.

12. The converter motor of claim 10, wherein the heat sink is thermally conductively adhesively bonded on a side of the second printed circuit board segment which faces away from a side with the lossy components.

13. The converter motor of claim 9, wherein the heat sink is molded on a side of the central printed circuit board segment which faces away from the side with the lossy components.

14. The converter motor of claim 9, wherein the first printed circuit board segments are encapsulated inside the converter housing.

15. The converter motor of claim 9, wherein the motor is a permanent-magnet synchronous motor.

16. The converter motor of claim 14, wherein the first printed circuit board segments are encapsulated with a thermally conductive plastic.

17. The converter motor of claim 14, wherein the first printed circuit board segments are encapsulated with a thermally insulating plastic.
